(19) United States
(12) Patent Application Publication
(10) Pub. No.: US 2003/0002589 A1
(43) Pub. Date: Jan. 2, 2003

(54) Serial communication circuit and serial transmitting and receiving system

(76) Inventors: Kotaro Suzuki, Hyogo (JP); Takeshi Fujii, Hyogo (JP)

Correspondence Address: Platon N. Mandros, BURNS, DOANE, SWECKER & MATHIS, L.L.P., P.O. BOX 1404, Alexandria, VA, 22313-1404, US

(21) Appl. No.: 10/144,730

(22) Filed: May 15, 2002

(30) Foreign Application Priority Data
Jun. 28, 2001 (JP) 2001-197064

(51) Int. Cl. H04L 27/20; H04L 27/12; H04L 27/04; H04L 27/00

(52) U.S. Cl. 375/259; 375/295

(57) ABSTRACT

To eliminates the need for synchronization of operating clocks with each other in serial communications between the semiconductor integrated circuit at the transmitting and receiving sides. In the reloading control unit of the circuit at the transmitting side, a second reloading register is set in a timer after setting a first reloading register when DATA=0, while when DATA=1, the first reloading register is set in the timer after setting the second reloading register. Accordingly, waveforms having different duty ratios are outputted. In the data converting circuit of the circuit at the receiving side, the waveforms are converted into “0”, “1” based on the ratio of the H,L level periods of each waveform to supply them to a serial I/O.

### BACKGROUND OF THE INVENTION

1. Field of the Invention

This invention relates to a serial communication circuit incorporated in transmitting and receiving sides of a microcomputer or the like for serially transmitting and receiving data and a serial transmitting and receiving system consisting of transmitting and receiving sides, and more particularly to a serial communication circuit and a serial transmitting and receiving system operable without relying on clock synchronization between the transmitting and receiving sides.

2. Description of the Related Art

FIG. 6 is a connection diagram of a conventional two-wire serial communication circuit.

Referring to FIG. 6, the serial communication circuit comprises a semiconductor integrated circuit at the transmitting side 101; a semiconductor integrated circuit at the receiving side 102. “A” represents a signal line; “B” a data line; and “PORT”, “TxD”, and “RxD” terminal.

Next, the operation of a conventional two-wire serial communication circuit will be described.

The semiconductor integrated circuit 101 at the transmitting side sends a signal from the PORT for controlling communications, and outputs data to be transmitted from the TxD. On the other hand, the semiconductor integrated circuit 102 at the receiving side receives the signal input from the PORT for controlling the communications, and the data to be received from the RxD. The signal of the signal line A permits data transmission/reception only during an “H” period. The data line B carries data to be transmitted/received between the two semiconductor integrated circuits 101,102. The semiconductor integrated circuits 101,102 are both operated respectively based on independent oscillation circuits.

It should be noted that these circuits 101,102 are operated at substantially equal frequencies within an error tolerance defined in specifications.

FIG. 7 is a timing chart of the two-wire serial communication circuit.

In FIG. 7, “PORT” represents the signal line A of FIG. 6; “CLK 1” an operating clock at the transmitting side; “DATA” the data line B of FIG. 6; and “CLK 2” an operating clock at the receiving side. As can be seen from the chart, phases of waveforms between the CLK 1 and the CLK 2 are slightly shifted. The semiconductor integrated circuit 102 at the receiving side fetches the DATA at the trailing edge of the CLK 2. Thus, there is a possibility that a malfunction will be broken if the data is fetched at the trailing edge of the CLK 2 when a phase of the CLK 1 is shifted therefrom during the unsettled state of data, for example at a point C of FIG. 7.

However, there has been a problem that, since the conventional serial transmission circuit is configured as above, a communication error could be occurred at the semiconductor integrated circuit at the receiving side during the unsettled state of data, a clock synchronization being needed between the semiconductor integrated circuits at the receiving and transmitting sides to avoid the occurrence of the communication error.

### SUMMARY OF THE INVENTION

The present invention has been made to solve the above problems, and it is an object of the invention to provide a serial communication circuit and a serial transmitting and receiving system for accomplishing serial communications without relying on clock synchronization between the semiconductor integrated circuits at the receiving and transmitting sides.

A serial communication circuit according to the invention comprises two or more reloading registers in which given data are being stored, respectively; a first counting means for counting a first data and a second data as the given data set from the reloading registers so as to generate a duty ratio of serial data to be transmitted; and data converting means for converting serial data into waveforms having the duty ratio generated by the first counting means to transmit the waveforms.

A serial communication circuit according to the invention comprises a second counting means for counting a first and a second level periods when the waveforms transmitted from the transmitting side: and comparing means for comparing the counted values of the first and second level periods with each other by the second counting means

A serial transmitting and receiving system according to the invention comprises two or more reloading registers in which given data are being stored, respectively; a first counting means for counting a first data and a second data as the given data set from the reloading registers so as to generate a duty ratio of serial data to be transmitted; data converting means for converting serial data into waveforms having the duty ratio generated by the first counting means to transmit the waveforms; a second counting means for counting a first and a second level periods when the waveforms transmitted from the data converting means: and comparing means for comparing the counted values of the first and second level periods with each other by the second counting means.

The first counting means starts a counting operation of the second data after a counting operation of the first data has finished.

The duty ratio is a value other than 1:1.

The first level period is H level, and the second level period is L level.

Further comprising reloading register control means for setting the stored values in the corresponding reloading registers, based on a level of a serial data.

A serial communication circuit according to the invention comprises two or more reloading registers in which given data are being stored, respectively; a first counting means for counting a first data and a second data as the given data which are set from the reloading registers so as to generate a duty ratio for serial data to be transmitted; data converting means for converting serial data into waveforms having the duty ratio generated by the first counting means to transmit the waveforms; and control means for controlling writing operation of data to be stored in the reloading registers.

A serial transmitting and receiving system comprises two or more reloading registers in which given data are being stored, respectively; a first counting means for counting a first data and a second data as the given data which are set from the reloading registers so as to generate a duty ratio for serial data to be transmitted; data converting means for converting serial data into waveforms having the duty ratio generated by the first counting means to transmit the waveforms; a second counting means for counting a first and a second level periods when the waveforms transmitted from the data converting means: comparing means for comparing the counted values of the first and second level periods with each other by the second counting means; and control means for controlling writing operation of data to be stored in the reloading registers.

Each of the reloading register has a reading/writing function.

The circuit further comprises error recognition means for recognizing a communication error of received data based on the result of the comparing means when a duty ratio of the received data as a waveform ratio, gets worse than a fixed value.

### BRIEF DESCRIPTION OF THE DRAWINGS

FIG. 1 is a block diagram showing a configuration of a serial communication circuit according to a first embodiment of the present invention.

FIG. 2 is a timing chart showing an example of data outputted to a signal line F of the circuit shown in FIG. 1.

FIG. 3 is a block diagram showing a specific example of a received data converting circuit.

FIG. 4 is a block diagram showing a specific example of a semiconductor integrated circuit at the transmitting side according to a second embodiment of the invention.

FIG. 5 is a block diagram showing a specific example of a semiconductor integrated circuit at the receiving side according to a third embodiment of the invention.

FIG. 6 is a block diagram showing a connection example of a conventional two-wire serial communication circuit.

FIG. 7 is a timing chart of communications of the conventional two-wire serial communication circuit.

Throughout the figures, the same reference numerals, and characters, unless otherwise noted, are used to denote like features, elements, components, or portions of the illustrated embodiments.

### DESCRIPTION OF THE PREFERRED EMBODIMENTS

The preferred embodiments of the present invention will be described in detail with reference to the attached drawings.

### First Embodiment

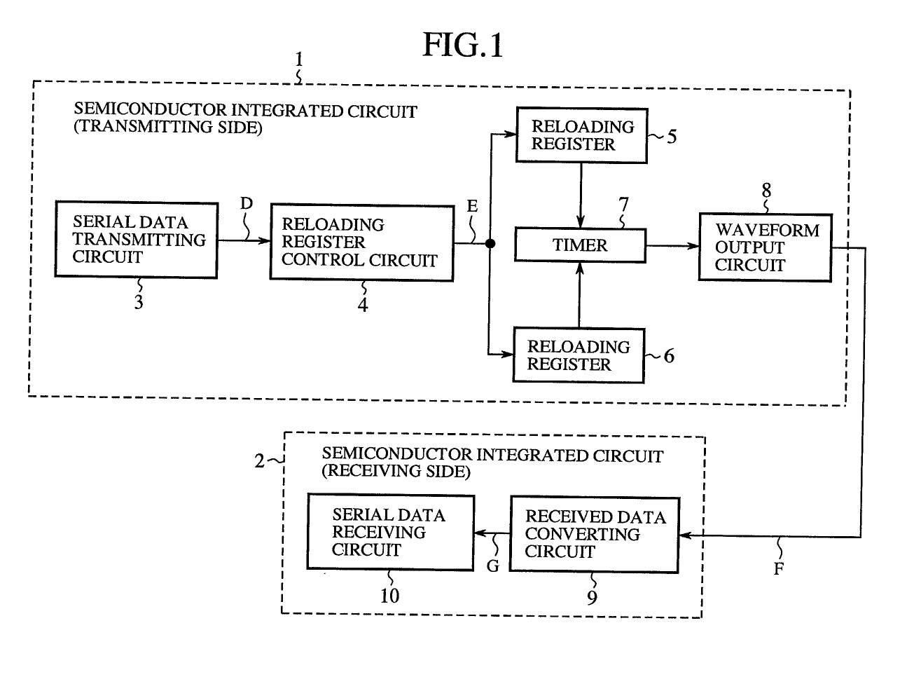

FIG. 1 is a block diagram showing a serial communication circuit according to a first embodiment of the invention.

Referring to FIG. 1, a semiconductor integrated circuit 1 at the transmitting side comprises a serial data transmission circuit 3; a reloading register control circuit (control means) 4; reloading registers 5,6, in which fixed values “01H”, “03H” are respectively set, a timer 7, and a waveform output circuit (data converting means) 8. The semiconductor integrated circuit 1 at the transmitting side transmits a serial data through signal lines D, E and so on.

On the other hand, a semiconductor integrated circuit 2 at the receiving side comprises a received data converting circuit (second counting means and comparing means) 9; and a serial data receiving circuit 10. The semiconductor integrated circuit 2 at the receiving side receives the serial data transmitted from the transmitting side through signal lines F, G and so on.

In the semiconductor integrated circuit 1 at the transmitting side, the serial data transmission circuit 3 is a communication circuit of a clock synchronous type. Data more than 2 bits to be sent are transmitted as binary data by shifting by 1 bit from higher bits (or lower bits). The reloading register control circuit 4 first sets the data “03H” of the reloading register 5 in the timer 7 when the timer 7 underflows during data input through the signal line D is at a first level, i.e., “H” (or “1”), and then sets the data “01H” of the reloading register 6 in the timer 7 when the timer 7 underflows. When data input through the signal line D is at a second level, i.e., “L” (or “0”), the reloading register control circuit 4 first sets the data of the reloading register 6 in the timer 7 when the timer 7 underflows, and then sets the data of the reloading register 5 in the timer 7 when the timer 7 underflows.

In sum, the reloading register 5 sets a fixed value “03H” in the timer 7 in response to a command issued from the reloading register control circuit 4. In addition, the reloading register 6 sets a fixed value “01H” in the timer 7 in response to a command issued from the reloading register control circuit 4. The timer 7 counts down the set data, and then the data set from the corresponding reloading registers 5,6 when the timer underflows. The waveform output circuit 8 inverts data in response to an underflow signal from the timer 7, and outputs the inverted data as serial communication data.

On the other hand, in the semiconductor integrated circuit 2 at the receiving side, the received data converting circuit 9 includes a timer 11 and a comparator 14 (described later). The duration of the H,L periods of data input through the signal line F are counted by the timer 11. The count values of the H,L periods are compared with each other by the comparator 14. If the H period is longer, then the data is outputted as binary data “1”. Otherwise, then the data is outputted as binary data “0”. Then, transmitted data are received as binary data by shifting by 1 bit from higher bits by the serial data receiving circuit 10.

Next, the operation of the first embodiment will be described.

In the semiconductor integrated circuit 1 at the transmitting side, first, the data of “H” input from the serial data transmission circuit 3 through the signal line D is recognized by the reloading register control circuit 4. Accordingly, the data “03H” of the reloading register 5 is set in the timer 7, and counts down by the timer 7. When the timer 7 underflows, the data “01H” of the reloading register 6 is set in the timer 7, and counts down by the timer 7. Thus, the data of “H” fed through the signal line D is outputted as a signal of a duty ratio of 3:1 through the signal line F. The duty ratio means the rate of an “H” or “L” input period occupying one data cycle.

On the other hand, in the semiconductor integrated circuit 2 at the receiving side, the signal of the duty ratio 3:1 input through the signal line F, the “H” period of one cycle is counted by the timer 11 or the like in the received data converting circuit 9, and the counted result is held therein. Then, an “L” period is counted by the same means. These two counted results are in turn compared with each other to determine which is longer.

If the result of the comparison shows that the “H” period is longer, the data is converted into 1 bit data of “H”. Otherwise, then the data is converted into 1 bit data of “L”. The converted data is input through the signal line G to the serial data receiving circuit 10, and the reception of 1 bit data is finished. By repeating this process by 8 bits, 8 bit data can be transferred.

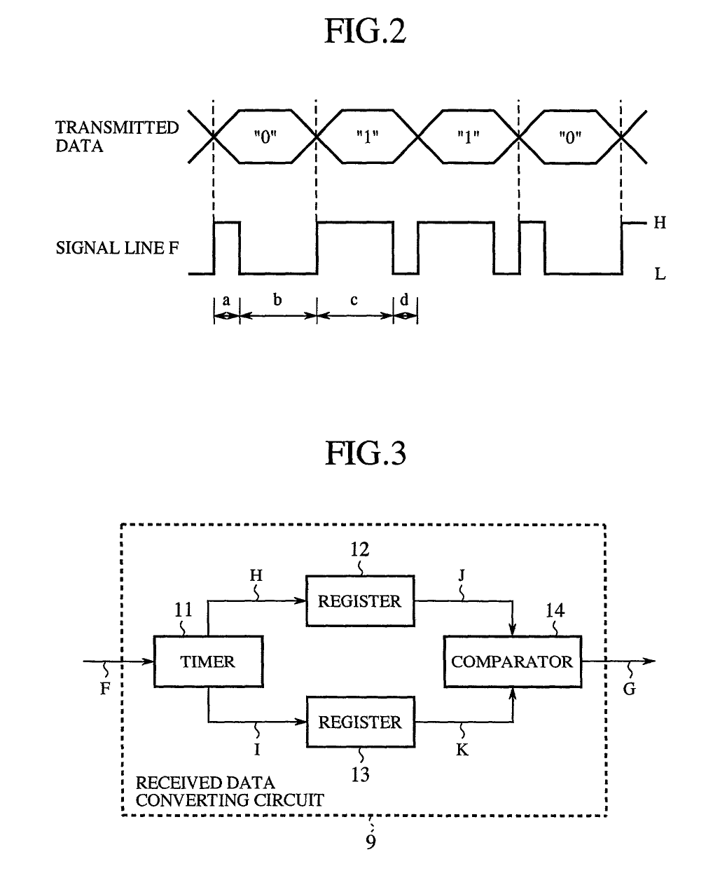

FIG. 2 is a timing chart showing an example of data outputted to the signal line of the circuit shown in FIG. 1.

FIG. 2 specifically shows a waveform outputted from the waveform output circuit 8 to the signal line F when data transmitted through the signal line D is “0110”. In FIG. 2 the duration of the waveforms is of ratios a:b=1:3 and c:d=3:1.

FIG. 3 is a block diagram showing a specific example of the received data converting circuit 9.

Referring to FIG. 3, the received data converting circuit 9 comprises a timer 11; registers 12,13; a comparator 14. This received data converting circuit 9 counts the “H” period of data input through the signal line F by the timer 11, and stores the counted value in the register 12. The received data converting circuit 9 also counts the “L” period of the data input through the signal line F by the timer 11, and stores the counted value in the register 13. Then, the data are input through signal lines J,K to the comparator 14. The values of the registers 12,13 are compared with each other by the comparator 14 to determine which is longer. If the value of the register 12 is larger, then “1” is outputted; otherwise “0” is outputted. Then, the outputted data is fed as serial data to the signal line G.

As mentioned above, according to the first embodiment, the use of the serial communication circuit enables communications between the semiconductor integrated circuits at the transmitting and receiving sides, even if communication speeds are not decided beforehand by the operating clocks at the transmitting and receiving sides. Further, communications can be carried out irrespective of the operating clock at the receiving side, even when the serial communication circuit is operated by using a circuit, e.g., a ring oscillator, which causes oscillation frequency to be changed by voltage fluctuation.

### Second Embodiment

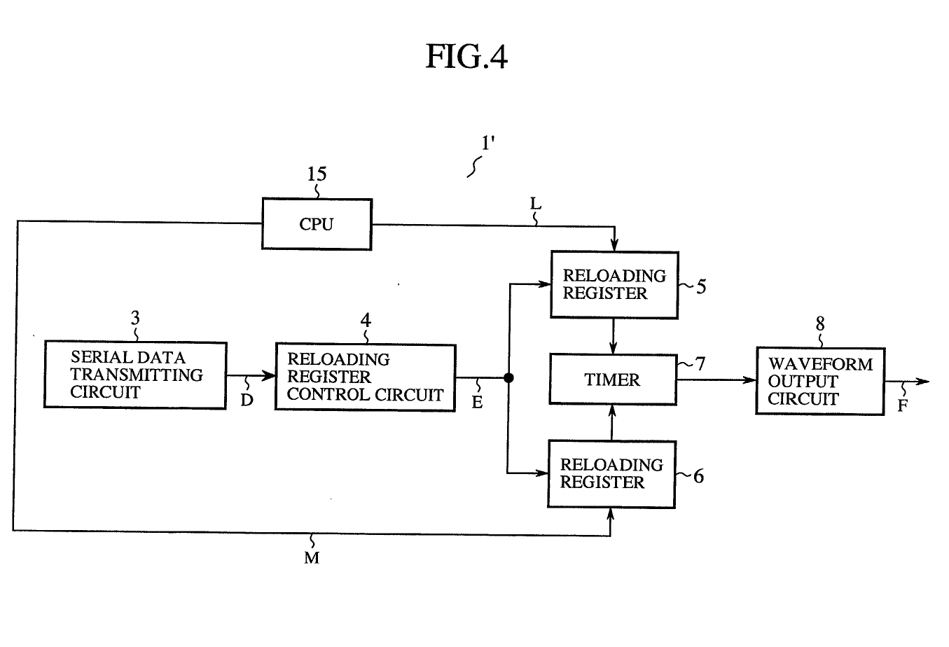

FIG. 4 is a block diagram showing a specific example of the semiconductor integrated circuit at the transmitting side according to a second embodiment of the invention.

Referring to FIG. 4, the semiconductor integrated circuit 1′ comprises a CPU 15 as a logical operation circuit in the semiconductor integrated circuit; a serial data transmission circuit 3; a reloading register control circuit 4; reloading registers 5, 6; a timer 7; and a waveform output circuit 8.

This embodiment is directed to one in which there is added a CPU 15 (control means) to the above first embodiment shown in FIG. 1 and a set value is written in the reloading registers 5,6. In this embodiment, the configuration and operation of the semiconductor integrated circuit at the receiving side is the same as those of the semiconductor integrated circuit 2, and thus description thereof will be omitted.

Next, the operation of the second embodiment will be described.

In the circuitry shown in FIG. 4, the basic operation of the serial data transmission circuit 3, the reloading register control circuit 4, the reloading registers 5,6, the timer 7 and the waveform output circuit 8 are the same as those of the first embodiment, and thus only the operation which is different from that of the first embodiment will be described below. Implementation of a reading/writing function by software enables the CPU 15 to write set values respectively in the reloading registers 5,6 through signal lines L,M. Accordingly, it is possible to change the duty ratio 3:1 of the output signal from the waveform output circuit 8 illustrated in the first embodiment to another one depending on the use condition of a user.

As mentioned above, according to the second embodiment, optimal communication accuracy can be maintained, even if external factors cause fluctuation in the operating clock.

### Third Embodiment

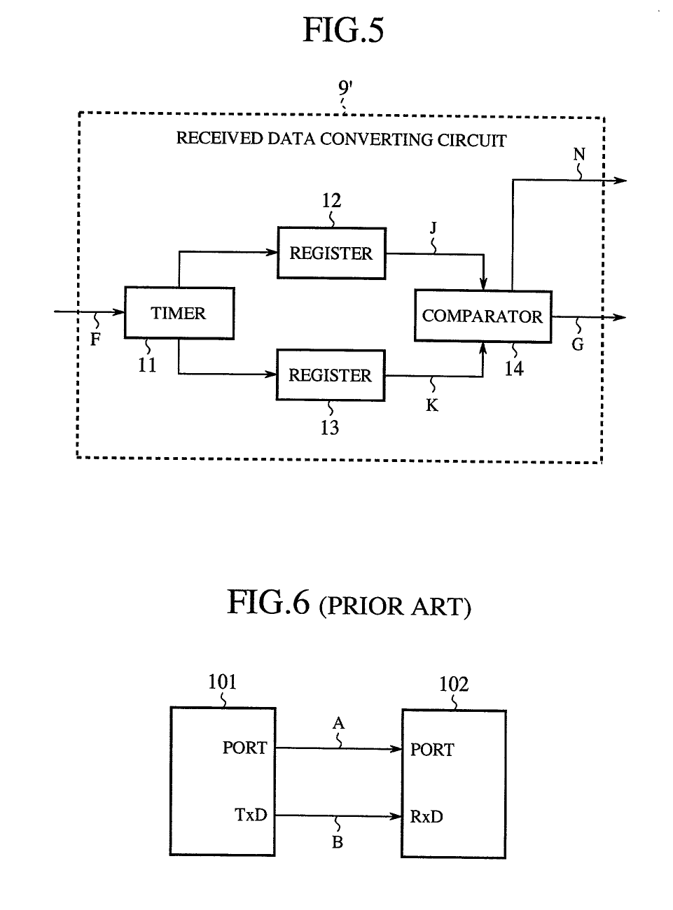

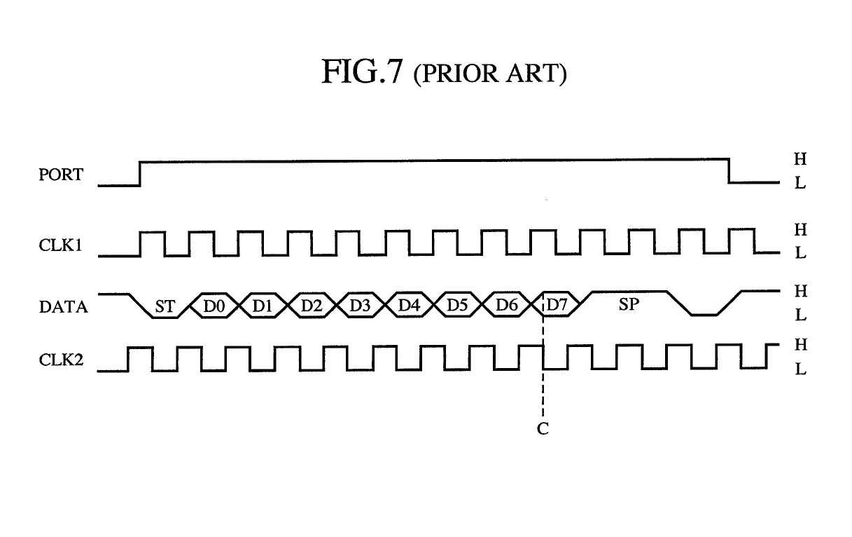

FIG. 5 is a block diagram showing a specific example of the semiconductor integrated circuit 9 at the receiving side according to a third embodiment of the invention.

Referring to FIG. 5, the semiconductor integrated circuit 9′ comprises a timer 11; registers 12,13; a comparator 14.

This embodiment is directed to one in which there is provided error recognition means, in the comparator 14 shown in FIG. 3, for outputting an error signal to an external unit (not shown) if a given duty ratio is not satisfied. In this embodiment, the semiconductor integrated circuit at the transmitting side is the same as that of the foregoing first or second embodiment, and thus description about the configuration and operation thereof will be omitted.

Next, the operation of the third embodiment will be described. Since the basic operation is similar to that of the first embodiment, only the operation which is different from the first embodiment will be described below. In the circuitry shown in FIG. 5, if the duty ratio of the data of the signal line F is not reached to a fixed ratio or higher when it is fetched into the received data converting circuit 9, the comparator 14 that has achieved this duty ratio is provided with the error recognition means therein for outputting an error signal to a signal line N. This error signal is fed to the comparator 14 or the external unit to feed back therefrom.

Alternatively, the error recognition means may be separately provided.

As mentioned above, according to the third embodiment, no communication errors are produced, and a malfunction caused by the communication error of the semiconductor integrated circuit can be prevented.

The advantages of the present invention can be summarized as follows.

The invention allows communications even when the operating clocks of the integrated circuits at the transmitting and receiving sides are out of synchronization with each other. This realizes serial communications without relaying on any synchronization between the operating clocks of the semiconductor integrated circuits at the receiving and transmitting sides. Therefore, the data converting means converts serial data into the waveforms having different duty ratios based on the duty ratio generated by the first counting means, and then transmits the waveforms. The second counting means counts the first and second level periods of each waveform, and then comparator compares the counted value of the first and second level periods with each other.

The invention converts the serial data into the waveforms having different duty ratios, which are not subject to the operating clocks. Therefore, the control means sets the set value of the corresponding reloading register in the first counting means based on the level of serial data.

The invention permits communications even when the operating clocks between the transmitting and receiving sides are out of synchronization with each other. This actualizes serial communications without relaying on any synchronization between the operating clocks of the semiconductor integrated. Therefore, the data converting means converts serial data into the waveforms having different duty ratios based on the duty ratio generated by the first counting means, and then transmits the waveforms. The second counting means counts the first and second level periods of each waveform, and then comparator compares the counted value of the first and second level periods with each other.

The invention optionally changes the duty ratio of the first and second level periods or the waveform ratio, and deals with fluctuation in the operating clocks caused by external factors. Therefore, the invention comprises the control means for controlling writing of data stored in the reloading registers and the reloading register has the rearing/writing function.

The invention prevents a malfunction caused by the communication error of the semiconductor integrated circuit. Therefore, the invention comprises the error recognition means for recognizing a communication error of received data based on the comparison result of the comparing means when the waveform ratio of the data gets worse than a fixed value.

While in each of the foregoing first to third embodiments, two reloading registers 5,6 (or registers 12,13) are adopted, three or more reloading registers may be used without restricting the invention to the foregoing embodiments. This offers more accurate serial communications. It should be understood by those skilled in the art that various modifications and changes may be made without departing from the sprit and scope of the invention.

Also, it should be noted that the invention meets all the objects mentioned above and also has the advantages of wide commercial utility, and that the invention has been set forth for purposes of illustration only and not of limitation. That is, the invention is limited only by the following claims which follow. Consequently, reference should be made to the following claims in determining the full scope of the invention.

What is claimed is:

1. A serial communication circuit for performing serial communications between semiconductor integrated circuit at the transmitting and receiving sides comprising:
two or more reloading registers in which given data are being stored, respectively;
a first counting means for counting a first data and a second data as said given data set from said reloading registers so as to generate a duty ratio of serial data to be transmitted; and
data converting means for converting serial data into waveforms having the duty ratio generated by said first counting means to transmit the waveforms.

2. A serial communication circuit for performing serial communications between semiconductor integrated circuit at the transmitting and receiving sides comprising:
a second counting means for counting a first and a second level periods when the waveforms transmitted from said transmitting side: and
comparing means for comparing the counted values of the first and second level periods with each other by said second counting means.

3. A serial transmitting and receiving system for performing serial communications between semiconductor integrated circuit at the transmitting and receiving sides comprising:
two or more reloading registers in which given data are being stored, respectively;
a first counting means for counting a first data and a second data as said given data set from said reloading registers so as to generate a duty ratio of serial data to be transmitted;
data converting means for converting serial data into waveforms having the duty ratio generated by said first counting means to transmit the waveforms;
a second counting means for counting a first and a second level periods when the waveforms transmitted from said data converting means: and
comparing means for comparing the counted values of the first and second level periods with each other by said second counting means.

4. The serial communication circuit according to claim 1, wherein said first counting means starts a counting operation of said second data after a counting operation of said first data has finished.

5. The serial communication circuit according to claim 1, wherein said duty ratio is a value other than 1:1.

6. The serial communication circuit according to claim 2, wherein said first level period is H level, and said second level period is L level.

7. The serial communication circuit according to claim 2, further comprising reloading register control means for setting the stored values in said corresponding reloading registers, based on a level of a serial data.

8. A serial communication circuit for performing serial communications between semiconductor integrated circuit at the transmitting and receiving sides comprising:
two or more reloading registers in which given data are being stored, respectively;
a first counting means for counting a first data and a second data as said given data which are set from said reloading registers so as to generate a duty ratio for serial data to be transmitted;
data converting means for converting serial data into waveforms having the duty ratio generated by said first counting means to transmit the waveforms; and
control means for controlling writing operation of data to be stored in said reloading registers.

9. A serial transmitting and receiving system for performing serial communications between semiconductor integrated circuit at the transmitting and receiving sides comprising:
two or more reloading registers in which given data are being stored, respectively;
a first counting means for counting a first data and a second data as said given data which are set from said reloading registers so as to generate a duty ratio for serial data to be transmitted;
data converting means for converting serial data into waveforms having the duty ratio generated by said first counting means to transmit the waveforms;
a second counting means for counting a first and a second level periods when the waveforms transmitted from said data converting means:
comparing means for comparing the counted values of the first and second level periods with each other by said second counting means; and
control means for controlling writing operation of data to be stored in said reloading registers.

10. The serial communication circuit according to claim 8, wherein each of said reloading register has a reading/writing function.

11. The serial communication circuit according to claim 2, wherein the circuit further comprises error recognition means for recognizing a communication error of received data based on the result of said comparing means when a duty ratio of the received data as a waveform ratio, gets worse than a fixed value.
